(19) United States
(12) Patent Application Publication
(10) Pub. No.: US 2020/0300013 A1
(43) Pub. Date: Sep. 24, 2020

(54) AIRCRAFT HINGE APPARATUS AND RELATED METHODS FOR USE OF THE SAME

(71) Applicant: Harper Engineering Co., Renton, WA (US)

(72) Inventor: David Chadwell, Renton, WA (US)

(21) Appl. No.: 16/784,114

(22) Filed: Feb. 6, 2020

Related U.S. Application Data
(60) Provisional application No. 62/821,307, filed on Mar. 20, 2019.

(51) Int. Cl. E05D 3/14; B64C 1/14; E05D 11/10

(52) U.S. Cl. CPC E05D 3/147; E05Y 2900/502; E05D 11/1057; B64C 1/1461

(57) ABSTRACT

A hinge apparatus can include a frame component of an aircraft interior component, a door component coupled to an aircraft door assembly, and a linkage assembly operable to rotatably move the door component between an open configuration, a partially open configuration, and a closed configuration. The linkage assembly can include a first hinge body coupled to the door component, a second hinge body coupled to the frame component, a main link pivotably coupled to the first hinge body and having a main link surface, and a first link pivotably coupled to the second hinge body and pivotably coupled to the main link. The first link may have a first link surface that is sized and shaped to mate with the main link surface when the door component is in the partially open configuration, the mating preventing movement of the door component from the partially open configuration to the open configuration or the closed configuration. Related methods are also provided.

### BACKGROUND

### Technical Field

The present disclosure generally relates to aircraft interior components and, more particularly, to aircraft interior component hinges.

### Description of the Related Art

Aircraft generally include a wide variety of interior components. Aircraft interior components, for example, galley doors, passenger service units, lavatory doors, galleys, closets, and other interior furnishings generally are hingedly moveable between open and closed positions. In general, such interior furnishings may include a door component and a door jamb or frame. The door component is generally moveable hingedly about the doorjamb.

Conventional hinge assemblies of aircraft interiors generally include complex spring mechanisms that hold or move the doors between open and closed positions. It is desirable for many aircraft applications to simplify the hinge mechanisms while at the same time providing a large rotary radius by, among other things, eliminating or reducing the number of moving parts, such as springs.

### BRIEF SUMMARY

The various implementations of hinge apparatuses described herein provide hinge apparatuses that are operable without any spring or biasing mechanisms in an efficient, robust, and compact manner. The various implementations of hinge apparatuses described herein provide hinge apparatuses that have a large rotary radiuses, including rotatably moving door components at least 180 degrees, with reduced moving parts. For example, in one non-limiting, example implementation, a hinge apparatus can be summarized as including a frame component of an aircraft interior component, a door component coupled to an aircraft door assembly, and a linkage assembly operable to rotatably move the door component between an open configuration, a partially open configuration, and a closed configuration. The linkage assembly may include a first hinge body coupled to the door component, a second hinge body coupled to the frame component, a main link pivotably coupled to the first hinge body and having a main link surface, and a first link pivotably coupled to the second hinge body and pivotably coupled to the main link. The first link may have a first link surface that is sized and shaped to mate with the main link surface when the door component is in the partially open configuration, the mating preventing movement of the door component from the partially open configuration to the open configuration.

In another, non-limiting, example implementation, a method for operating an aircraft door can be summarized as including coupling a frame component of a hinge apparatus to an aircraft door frame, coupling a door component of the hinge apparatus to the aircraft door, coupling a linkage assembly of the hinge apparatus to the door component and the frame component, and operating the aircraft door between open, closed, and partially open configurations. The operating may include pivotably moving the door component from the closed configuration to the partially open configuration via a main link of the linkage assembly and a first link of the linkage assembly, and mating a main link surface of the linkage assembly with a first link surface of the first link when the door component is in the partially open configuration.

BRIEF DESCRIPTION OF THE SEVERAL VIEWS OF THE DRAWINGS

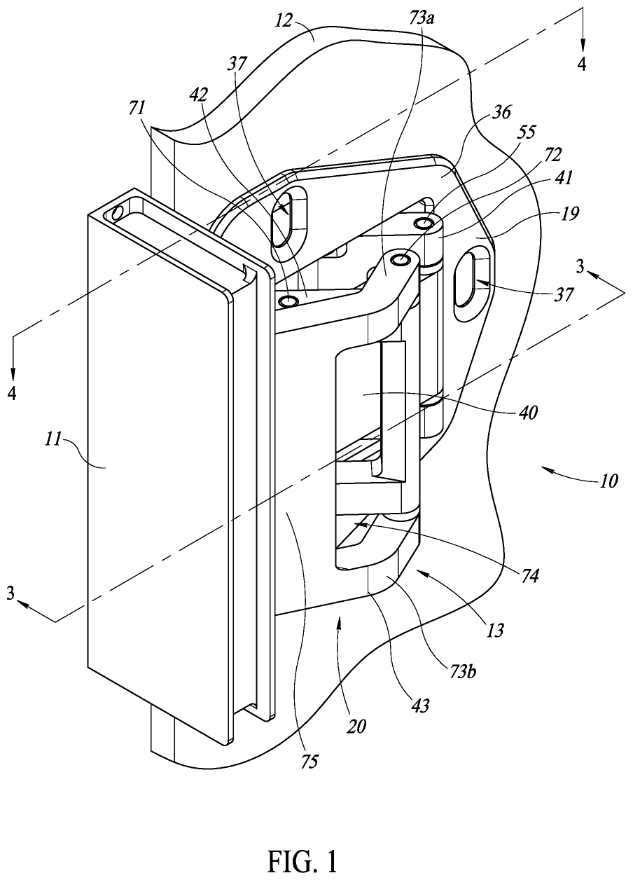

FIG. 1 is an isometric view of a hinge apparatus in a closed configuration, according to one example, non-limiting implementation.

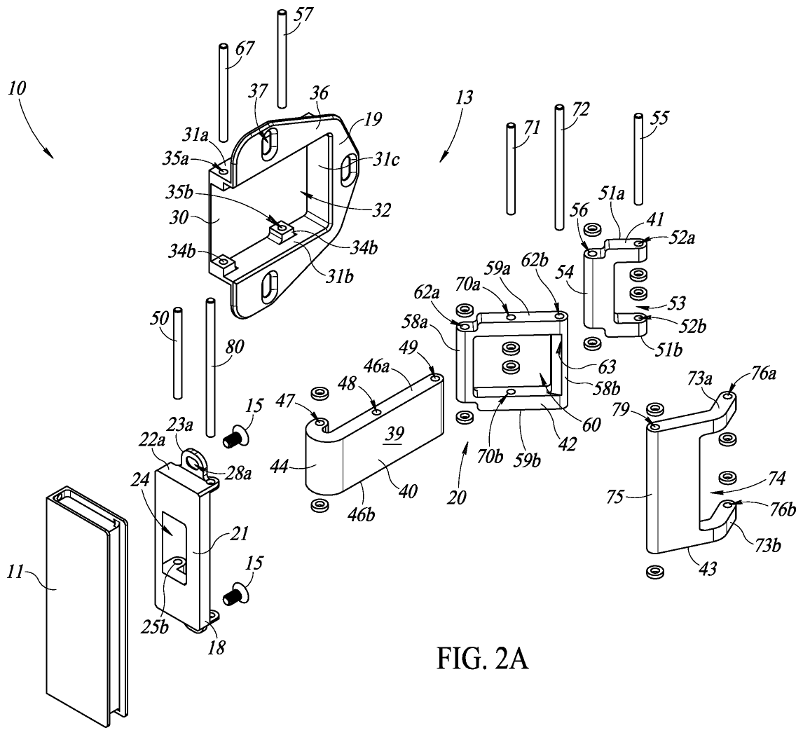

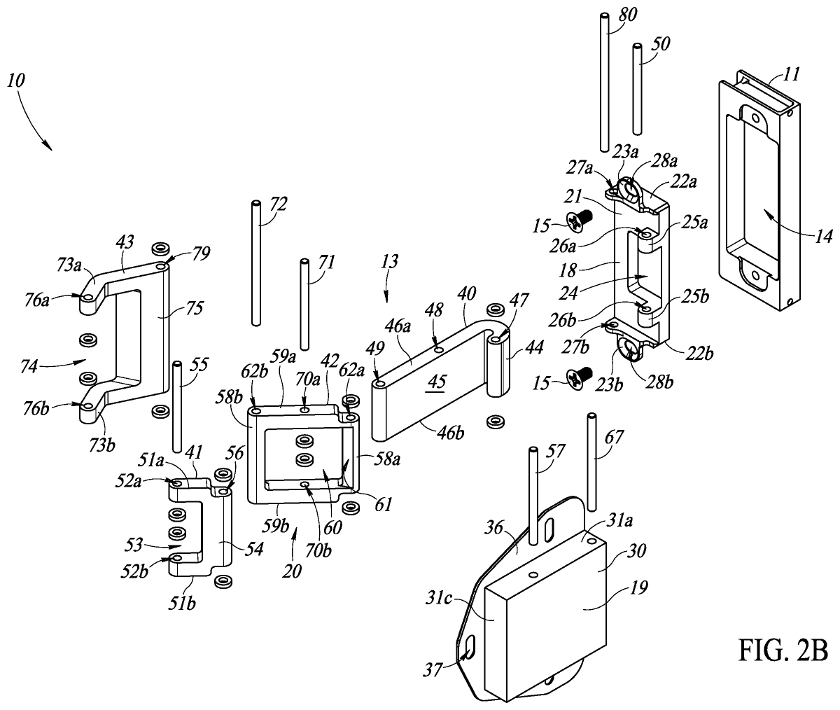

FIG. 2A is an exploded view of the hinge apparatus of FIG. 1.

FIG. 2B is another exploded view of the hinge apparatus of FIG. 1.

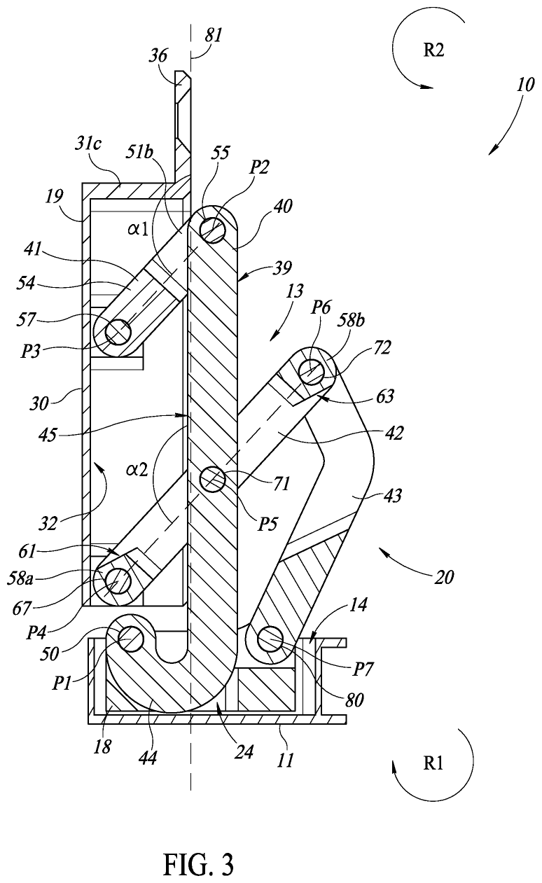

FIG. 3 is a cross-sectional view of the hinge apparatus of FIG. 1, taken along line 3-3.

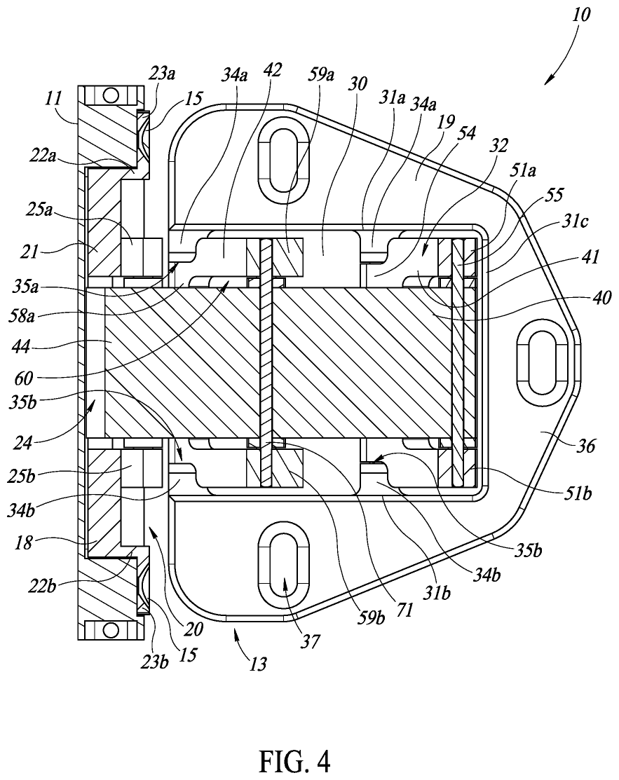

FIG. 4 is a cross-sectional view of the hinge apparatus of FIG. 1, taken along line 4-4.

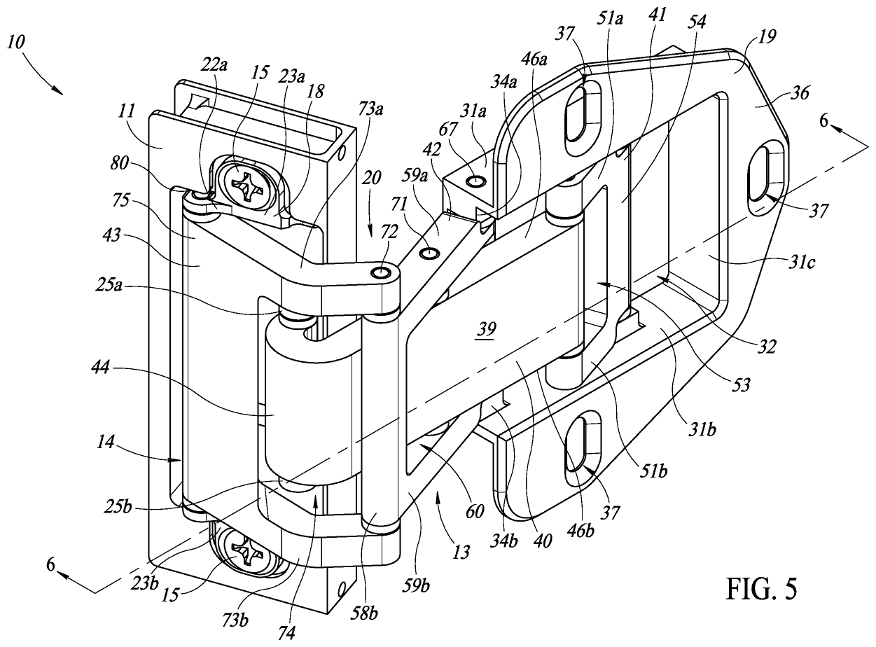

FIG. 5 is an isometric view of the hinge apparatus of FIG. 1 in a partially open configuration.

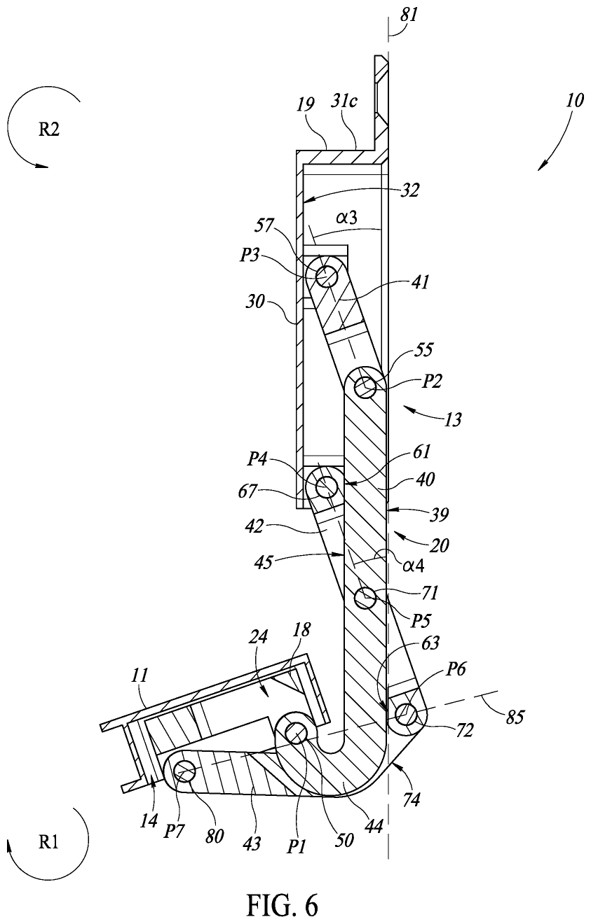

FIG. 6 is a cross-sectional view of the hinge apparatus of FIG. 5, taken along line 6-6.

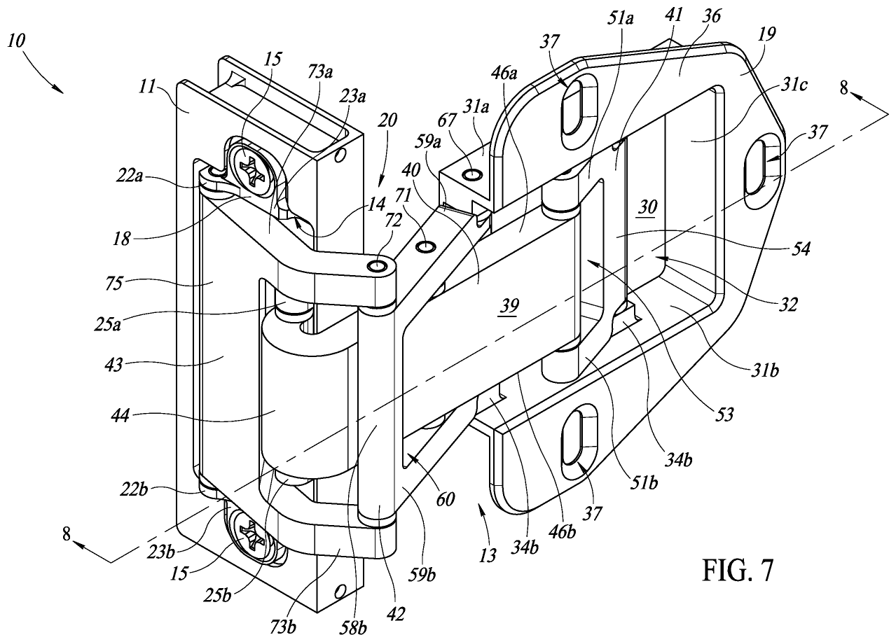

FIG. 7 is an isometric view of the hinge apparatus of FIG. 1 in an open configuration.

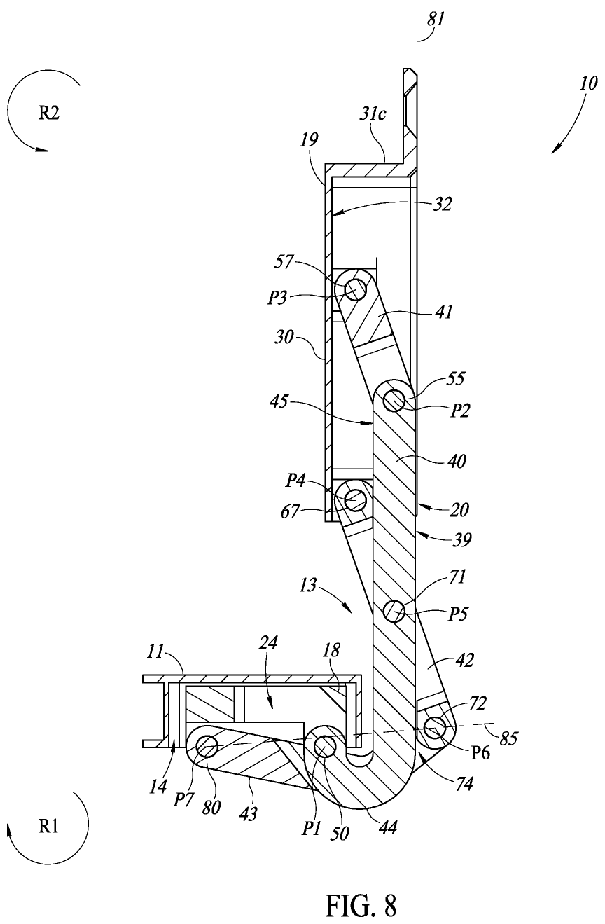

FIG. 8 is a cross-sectional view of the hinge apparatus of FIG. 7, taken along line 8-8.

### DETAILED DESCRIPTION

In the following description, certain specific details are set forth in order to provide a thorough understanding of various disclosed embodiments or implementations. However, one skilled in the relevant art will recognize that embodiments or implementations may be practiced without one or more of these specific details, or with other methods, components, materials, etc. In other instances, well-known structures associated with payload components, hinges, latches, aircraft interior furnishings, aircraft doors, aircraft frames, or other systems and apparatuses of aircrafts have not been shown or described in detail to avoid unnecessarily obscuring descriptions of the embodiments or implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or implementation. Thus, the appearances of the phrases “in one embodiment,” “in one implementation,” “in an embodiment,” or “in an implementation” in various places throughout this specification are not necessarily all referring to the same embodiment or implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

FIGS. 1-8 illustrate a hinge apparatus 10, according to one example, non-limiting implementation, in various configurations. The hinge apparatus 10 is moveable between a closed configuration, an open configuration, and an intermediate or partially open configuration. As described in more detail herein, the hinge apparatus 10 is generally operable to provide for rotary capability with an extended rotary movement and omits any spring loaded mechanisms.

The hinge apparatus 10 includes a door component 11, a frame component 12, and a hinge assembly 13. In general, the door component 11 is generally sized and shaped to couple the hinge assembly 13 to a door of an aircraft. For example, the door may comprise a lavatory door, an aircraft galley door, a closet door, or other interior furnishing component that closes and opens to provide access to an interior volume of such component. The door component 11 includes a first hinge recess 14 that is sized and shaped to receive therein the hinge assembly 13 or, more particularly, certain portions of the hinge assembly 13. As described in more detail below, the door component 11 is generally coupled to the hinge assembly 13 via one or more first fasteners 15.

The frame component 12, as shown in FIG. 1 (and removed in FIGS. 2-8 for clarity of description and illustration), in general, is sized and shaped to couple the hinge assembly 13 to a frame structure of an aircraft. For example, the frame component 12 may comprise a door jamb or other frame structure of an aircraft. The frame component 12 also includes a hinge recess that is sized and shaped to receive therein the hinge assembly 13 or, more particularly, certain portions of the hinge assembly 13. The frame component 12 is generally coupled to the hinge assembly 13 via one or more first fasteners.

The hinge assembly 13 includes a first hinge body 18, a second hinge body 19, and a linkage assembly 20. The first hinge body 18 includes a first base flange 21, a pair of first side walls 22a, 22b, and a pair of body tabs 23a, 23b. The first base flange 21 includes a first link recess 24 and a pair of coupling portions 25a, 25b protruding outwardly from the first base flange 21. The first link recess 24 is sized and shaped to receive therein portions of the linkage assembly 20 as described in more detail below. Each coupling portion 25a, 25b includes coupling apertures 26a, 26b that are sized and shaped to couple to portions of the linkage assembly 20 as described in more detail below. Each first side wall 22a, 22b is spaced apart from the other and includes a first wall aperture 27a, 27b that is sized and shaped to couple to portions of the linkage assembly 20 as described in more detail below. Each body tab 23a, 23b includes a respective body aperture 28a, 28b. The body aperture 28a, 28b is sized and shaped to coupleably receive the one or more first fasteners 15. In this manner, the first hinge body 18 is received in the first hinge recess 14 of the door component 11, with the one or more first fasteners 15 coupling the first hinge body 18 to the door component 11.

The second hinge body 19 is generally sized and shaped to couple to the frame component 12. The second hinge body is fixedly coupled to the frame component 12. The second hinge body 19 includes a second base flange 30 with external walls 31a, 31b, 31c protruding outwardly to define a second link recess 32. The second link recess 32 is sized and shaped to receive therein portions of the linkage assembly 20 as described in more detail below. The external wall 31a includes a pair of coupling elements 34a and the external wall 31b includes a pair of coupling elements 34b. Each of the coupling elements 34a is spaced apart from each other and includes coupling apertures 35a sized and shaped to coupleably receive portions of the linkage assembly 20 as described in more detail below. Each of the coupling elements 34b is spaced apart from each other and includes coupling apertures 35b sized and shaped to coupleably receive portions of the linkage assembly 20 as described in more detail below. The second hinge body 19 includes a peripheral flange 36 that extends from the external walls 31a, 31b, 31c. The peripheral flange 36 includes one or more slot apertures 37 that are sized and shaped to couple to the frame component 12 via fasteners to a frame component of an aircraft door, such as a doorjamb. The one or more slot apertures 37 are generally elongated to allow for alignment and adjustment of the second hinge body 19 during assembly.

The linkage assembly 20 is generally sized, shaped, and arranged in the first and second hinge bodies 18, 19 to allow for pivotable movement of the door component 11. The linkage assembly 20 includes a main link 40, a first link 41, a second link 42, and a third link 43. The main link 40 has a generally hook-shaped cross-sectional profile with a curved portion 44. The main link 40 includes a first main link surface 39, an opposing second main link surface 45, and a pair of main link side walls 46a, 46b. The main link side walls 46a, 46b include a first main link aperture 47, a second main link aperture 48, and a third main link aperture 49. Each of the first, second, and third main link apertures 47, 48, 49 extends through the main link side walls 46a, 46b. As illustrated in FIGS. 1-8, the curved portion 44 of the main link 40 is received in the first link recess 24 of the door component 11 at least when the hinge apparatus 10 is in the closed configuration, and is sandwiched between the pair of coupling portions 25a, 25b. A main link pin 50 is sized and shaped to be received through the main link aperture 47, and pivotably couples the first hinge body 18 to the main link 40 to allow the first hinge body 18 and the main link 40 to pivotably rotate about each other via the main link pin 50, which defines a first pivot point P1.

The first link 41 has a generally C-shaped cross-sectional profile having a pair of spaced apart first link arms 51a, 51b that define a first link recess 53, and a first base portion 54. The first link arms 51a, 51b include first main link apertures 52a, 52b extending therethrough. The first link recess 53 is sized and shaped to receive the main link 40 and allow the main link 40 to moveable therein. The main link 40 is sandwiched between the first link arms 51a, 51b. When received in the first link recess 53, the first link 41 is pivotably coupled to the main link 40 via a first link pin 55, which is sized and shaped to be received in the first link apertures 52a, 52b and the third main link aperture 49. In this manner, the first link 41 and the main link 40 are pivotably rotatable about each other via the first link pin 55, which defines a second pivot point P2. As illustrated in FIGS. 1-8, the first link 41 is sized, shaped, and arranged to be received in the second link recess 32 of the second hinge body 19, at least when in the closed configuration and moveable therein. In particular, the first base portion 54 includes a first base portion aperture 56 extending therethrough. When received in the second link recess 32, the first base portion 54 is sandwiched between the coupling elements 34a, 34b. The first link 41 is pivotably coupled to the second hinge body 19 via a second hinge pin 57, which is sized and shaped to be received in the first base portion aperture 56 and the coupling apertures 35a, 35b. In this manner, the first link 41 to pivotably rotate about the second hinge body 19 via the second hinge pin 57, which defines a third pivot point P3.

The second link 42 includes a second link body base portion 58a and a second link base portion 58b spaced apart from each other by a pair of second link walls 59a, 59b to define a second link recess 60. The second link recess 60 is sized and shaped to angularly receive the main link 40 as described in more detail below. The second link body base portion 58a includes a first main link mating surface 61 that extends angularly relative to a central axis of the second link 42. The second link body base portion 58a includes a second link body base aperture 62a extending therethrough. The second link base portion 58b also includes a second main link mating surface 63 that extends angularly relative to the central axis of the second link 42. The second link base portion 58b includes a second link base portion aperture 62b that extends therethrough. The second link body base aperture 62a is sized and shaped to pivotably couple the second link 42 to the second hinge body 19 via a second base pin 67 to allow the second link 42 to pivotably rotate about the second hinge body 19, the second base pin 67 defining a fourth pivot point P4. In particular, the second link 42 is received in the second link recess 32 of the second hinge body 19, and the second link 42 is sandwiched between the coupling elements 34a, 34b. Each second link wall 59a, 59b includes a corresponding second link aperture 70a, 70b, which is sized and shaped to pivotably couple the second link 42 with the main link 40 via second link pin 71. The second link pin 71 is sized and shaped to be received in the second link apertures 70a, 70b and the second link main aperture 48, which when received, allows the second link 42 and the main link 40 to pivotably move about each other via second link pin 71, which defines a fifth pivot point P5. The second link base aperture 62b is sized and shaped to pivotably couple the second link 42 to the third link 43 via a third link pin 72, which defines a sixth pivot point P6.

In particular, the third link 43 has a generally C-shaped cross-sectional profile having a pair of spaced apart third link arms 73a, 73b that define a third link recess 74 and a third base portion 75. The third link arms 73a, 73b include third link apertures 76a, 76b extending therethrough. The third link recess 74 is sized and shaped to receive the main link 40 at least when in the closed configuration and which is moveable therein, and is sandwiched between the third link arms 73a, 73b during movement of the main link 40 between the open and closed configurations of the hinge apparatus 10. When received in the third link recess 74, the third link 43 is pivotably coupled to the second link 42 via third link pin 72, which is sized and shaped to be received in the third link apertures 76a, 76b and the second link base portion aperture 62b. In this manner, the third link 43 and the second link 42 are pivotably rotatable about each other via the third link pin 72, which as described above, defines the sixth pivot point P6. As illustrated in FIGS. 1-8, the third link 43 is sized, shaped, and arranged to be received in the first link recess 24 of the first hinge body 18. In particular, the third base portion 75 includes a third base portion aperture 79 extending therethrough. When received in the first link recess 24, the third base portion 75 is sandwiched between the first side walls 22a, 22b. The third base portion 75 is pivotably coupled to the first hinge body 18 via a hinge body pin 80, which is sized and shaped to be received in the first wall apertures 27a, 27b of the first side walls 22a, 22b and the third base portion aperture 79 to allow the first hinge body 18 and the third link 43 to pivotably move about each other via hinge body pin 80, which defines a seventh pivot point P7.

As described above, the hinge apparatus 10, in operation, is moveable between a closed configuration, illustrated in FIGS. 1, 3 and 4, a partially open configuration, illustrated in FIGS. 5 and 6, and an open configuration, illustrated in FIGS. 7 and 8. In particular, in the open configuration, the main link 40 is generally aligned with a vertical axis 81 of the hinge apparatus 10 and extends through the second link recess 60 of the second link 42. The first link 41 and the second link 42 are each oriented angularly at respective angles α₁ and α₂. As the door component 11 is rotatably moved in direction R1, the hinge apparatus 10 moves from the fully closed configuration to the partially open configuration. In particular, the first link 41 pivotably moves about the second hinge body 19 about pivot point P3, and is oriented angularly with respect to the vertical axis 81 at angle α₃, which is less than angle α₁. For example, angle α₁ may be an obtuse angle and α₃ may be an acute angle.

As the door component 11 is rotated in direction R1, the main link 40 and the first link 41 pivotably rotate about each other about pivot point P2. Pivotable rotation of the main link 40 and the door component 11 causes pivotable rotation of the second link 42. In particular, second link 42 and the main link 40 pivotably rotate about each other about pivot point P5 and the second link 42 pivotably rotates about second hinge body 19 about pivot point P4. In the partially open configuration of the hinge apparatus 10, the second link 42 is oriented angularly with respect to the vertical axis 81 at angle α₄, which is less than angle α₂. For example, angle α₄ may be an obtuse angle and α₂ may be an acute angle.

As the door component 11 rotates and the second link 42 rotates as described above, the third link 43 and the second link 42 pivotably rotate about each other about pivot point P6 and the third link 43 and the first hinge body 18 pivotably rotate about each other about pivot point P7. Further, as demonstrated in FIGS. 3 and 6 in detail, the door component 11 and the first hinge body 18 coupled thereto pivotably rotate about main link 40 about pivot point P1. In the partially open configuration, the door component 11 has rotated at an obtuse angle relative to the orientation of the door component 11 in the closed configuration, e.g., less than 180 degrees but more than 90 degrees. In the partially open configuration, the first main link surface 39 mates with the second main link mating surface 63 of the second link 42, and the second main link surface 45 mates with the first main link mating surface 61 of the second link 42. Moreover, as illustrated in FIG. 6, the first pivot point P1 is positioned above a plane 85 extending between seventh pivot point P7 and sixth pivot point P6. In this configuration, the main link 40 is substantially prevented from further rotational movement due to the contact of the mating surfaces of the second link 42 as described above. As the main link 40 is prevented from further rotation, other links of the linkage assembly (e.g., first link 41, second link 42, third link 43, etc.) are also prevented from further rotary movement.

As the door component 11 is further rotatably moved between the partially open configuration and the open configuration in direction R1, the hinge apparatus 10 is operable to allow one or more links (e.g., main link 40, first link 41, second link 42, third link 43, etc.) of the linkage assembly 20 to elastically deform and return to an undeformed configuration when the hinge apparatus 10 is in the open configuration. For example, in some embodiments, the third link 43 is sized and shaped to elastically deform between the partially open and open configurations. In particular, as the main link 40 is substantially prevented from moving due to the mating of the first main link surface 39 with the second main link mating surface 63 of the second link 42 and the second main link surface 45 with the first main link mating surface 61, the third link 43 elastically deforms due to the forces applied by rotational movement of the door component 11.

In particular, shortly prior to, or at the time of, the first pivot point P1 travelling or moving beyond the plane 85, the first main link surface 39 mates with the second main link mating surface 63 of the second link 42, and the second main link surface 45 mates with the first main link mating surface 61 of the second link 42. As the door component 11 is moved, the third link 43 elastically deforms as the first pivot point P1 travel or moves beyond plane 85. Thereafter, continued movement of the door component 11 causes the door component 11 and the first pivot point P1 to move below the plane 85, at which point the third link 43 has returned to its undeformed form. In particular, in the open configuration (FIGS. 7 and 8), the door component 11 has rotated approximately 180 degrees relative to the orientation of the door component 11 in the closed configuration. Moreover, as the first main link surface 39 is in mating alignment with the second main link mating surface 63 of the second link 42, and the second main link surface 45 is in mating alignment with the first main link mating surface 61 of the second link 42, the door component 11 remains in the open configuration; in other words, the door component 11 is detented in the open configuration. Further, while the third link 43 elastically deforms as the hinge apparatus 10 moves between the closed and open configurations, other links of the linkage assembly 20 may also undergo elastic deformation. For example, the main link 40, the first link 41, and the second link 42 may also undergo elastic deformation due to the mating alignment of the first main link surface 39 with the second main link mating surface 63 of the second link 42, and the second main link surface 45 is in mating alignment with the first main link mating surface 61 of the second link 42. Further, in some embodiments, the elastic deformation may be varied for each of the links of the linkage assembly 20. For example, in some implementations, a stiffness of the various links may be varied relative to each other. For example, main link 40 may have a higher stiffness than the third link 43. Also for example, a cross-sectional area or the Young's modulus of the main link 40 may be varied relative to the cross-sectional area or the Young's modulus of the third link 43, or any other link of the linkage assembly 20.

Conversely, to return the door component 11 from the open configuration to the closed configuration, rotary movement of the door component 11 in the rotary direction R2 causes the hinge apparatus 10 to move from the open configuration to the partially open configuration. In particular, as the door component 11 is rotated, the door component 11 and the main link 40 pivotably rotate about each other about pivot point P1. As the first main link surface 39 is in mating alignment with the second main link mating surface 63 of the second link 42, and the second main link surface 45 is in mating alignment with the first main link mating surface 61 of the second link 42, the third link 43 elastically deforms as the pivot point P1 travels or moves beyond plane 85 due to the applied forces of the rotation of the door component 11. Thereafter, shortly after the first pivot point P1 travels or moves below the plane 85, the third link 43 has returned to the undeformed state and is in the partially open configuration. Further, continued rotational movement of the door component 11 causes the first main link surface 39 to move out of mating alignment with the second main link mating surface 63 of the second link 42, and the second main link surface 45 to move out of mating alignment with the first main link mating surface 61 of the second link 42.

Thereafter, as the door component 11 continues to rotate in rotary direction R2, the first hinge body 18 and the main link 40 pivotably rotate about each other about pivot point P1, and the first hinge body 18 and the third link 43 pivotably rotate about each other about pivot point P7. Further, the second link 42 and the third link 43 pivotably rotate about each other about pivot point P6. As the second and third links 42, 43 pivotably rotate about each other, the second link 42 and the main link 40 pivotably rotate about each other about pivot point P5, and the second link 42 pivotably rotates about second hinge body 19 about pivot point P4. In addition, the first link 41 and the main link 40 pivotably rotate about each other about pivot point P2, and the first link 41 pivotably rotates about the second hinge body 19 about P3, until the hinge apparatus 10 is returned to the closed configuration.

As described above, the hinge apparatus 10 is moveable between open and closed configurations without any biasing devices, such as springs. The hinge apparatus 10, in contrast to spring loaded apparatuses, according to various implementations described herein can be operable via linkage assemblies 20 that include one or more links that can elastically deform and have stop or detent features that position the linkage assembly 20 in a stationary position until further elastic deformation moves the linkage assembly 20. Moreover, the various implementations described above can be combined to provide further embodiments.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A hinge apparatus, comprising:
a frame component of an aircraft interior component;
a door component coupled to an aircraft door assembly; and
a linkage assembly operable to rotatably move the door component between an open configuration, a partially open configuration, and a closed configuration, the linkage assembly including:
a first hinge body coupled to the door component;
a second hinge body coupled to the frame component;
a main link pivotably coupled to the first hinge body and having a main link surface; and
a first link pivotably coupled to the second hinge body and pivotably coupled to the main link, the first link having a first link surface that is sized and shaped to mate with the main link surface when the door component is in the partially open configuration, the mating preventing movement of the door component from the partially open configuration to the open configuration.

2. The hinge apparatus of claim 1, further comprising:
a second link pivotably coupled to the first hinge body and the first link, the second link sized and shaped to elastically deform when the door component moves between the partially open configuration and the open configuration or the closed configuration.

3. The hinge apparatus of claim 1 wherein the first link includes a recess that is sized and shaped to receive the main link, the main link pivotably moveable in the recess between a first position in which the door component is in the open configuration and a second position in which the door component is in the partially open configuration.

4. The hinge apparatus of claim 1 wherein the first link includes a body base portion and a link base portion spaced apart from each other to define a recess, the recess sized and shaped to receive the main link.

5. The hinge apparatus of claim 4 wherein at least one of the body base portion or the base portion includes the first link surface.

6. The hinge apparatus of claim 1, further comprising:
a third link pivotably coupled to the second hinge body and the main link, movement of the door component between the closed configuration and the partially open configuration pivotably moving the third link about the main link.

7. The hinge apparatus of claim 1 wherein the first link is angularly oriented relative to a vertical axis of the hinge apparatus at an obtuse angle when the door component is in the closed configuration.

8. The hinge apparatus of claim 7 wherein the first link is angularly oriented relative to the vertical axis of the hinge apparatus at an acute angle when the door component is in the partially open configuration.

9. The hinge apparatus of claim 1 wherein the door component rotatably moves 180 degrees from the closed configuration to the open configuration.

10. A method for operating an aircraft door, the method comprising:
coupling a frame component of a hinge apparatus to an aircraft door frame;
coupling a door component of the hinge apparatus to the aircraft door;
coupling a linkage assembly of the hinge apparatus to the door component and the frame component; and
operating the aircraft door between open, closed, and partially open configurations, the operating including:
pivotably moving the door component from the closed configuration to the partially open configuration via a main link of the linkage assembly and a first link of the linkage assembly; and
mating a main link surface of the linkage assembly with a first link surface of the first link when the door component is in the partially open configuration.

11. The method of claim 10, comprising:
pivotably moving a second link of the linkage assembly when the door component moves from the closed configuration to the partially open configuration; and
elastically deforming at least the second link to move the door component from the partially open configuration to the open configuration.

12. The method of claim 10, comprising:
pivotably moving a second link of the linkage assembly when the door component moves from the open configuration to the partially open configuration; and
elastically deforming at least the second link to move the door component from the open configuration to the partially open configuration.

13. The method of claim 10 wherein the door component rotatably moves 180 degrees between the open and closed configurations.

14. The method of claim 10 wherein mating the main link surface of the linkage assembly with the first link surface includes moving the main link within a recess disposed in the first link.

15. The method of claim 10 wherein pivotably moving the door component from the closed configuration to the partially open configuration includes moving the first link from an obtuse angular orientation relative to a vertical axis of the hinge apparatus to an acute angular orientation relative to the vertical axis of the hinge apparatus.
